(19) United States
(12) Patent Application Publication
(10) Pub. No.: US 2026/0203799 A1
(43) Pub. Date: Jul. 16, 2026

(54) AI Marketplace Trust and Monetization Engine with Predictive Scoring (IPS Plus)

(71) Applicant: dario chang, doral, FL (US)

(72) Inventor: dario chang, doral, FL (US)

(21) Appl. No.: 19/390,733

(22) Filed: Nov. 17, 2025

(51) Int. Cl. G06Q 30/0601; G06Q 40/08

(52) U.S. Cl. CPC G06Q 30/0601; G06Q 40/086; G06Q 2220/00

(57) ABSTRACT

A predictive market intelligence platform for artificial intelligence assets is disclosed. The system computes an Importance Prediction Score (IPS) by fusing cycle pattern vectors (CPV) and historical influence vectors (HIV) through multipath architectures including graph neural networks, temporal transformers, and optional Neural Hawkes encoders. IPS outputs include calibrated confidence intervals, explainability decompositions, and embedded provenance and consent proofs. The IPS packet conditions marketplace actions such as dynamic pricing, auction clearing, service-level allocation, tokenization, royalty distribution, and insurance primitives. Fraud detection integrates dual anomaly nets for edge and sequence anomalies, while calibration modules maintain confidence under distribution shift. Privacy, provenance, and consent layers enforce compliance, and sensitive computations execute within trusted environments with formal verification. The platform enables early discovery, monetization, and trust for AI models, datasets, and workflows across verticals including media, enterprise search, healthcare, and finance

Definitions—Importance Prediction Score (IPS); Cycle Pattern Vector (CPV); Historical Influence Vector (HIV); provenance confidence; consent token; IPS packet; spatiotemporal attention; Mixture of Experts (MoE) fusion head.

Problem Statement—AI ecosystems contain many interacting assets whose commercial value emerges dynamically; existing systems fail to combine cyclical modeling, influence graphs, calibrated uncertainty, continual learning, privacy, fraud suppression, and monetization in a single auditable pipeline.

Summary of Invention—The platform computes IPS by fusing CPV and HIV using multipath architectures including graph neural networks, temporal transformers, and Neural Hawkes encoders, with optional mixture-of-experts and spatiotemporal attention. IPS outputs include explainability, calibrated confidence, and embedded provenance and consent proofs. IPS conditions marketplace actions via reinforcement-learning feedback loops, causal control, and risk-adjusted monetization; sensitive computations and settlement logic are protected by trusted execution environments and formal verification.

Primary Modules Overview—Interaction Event Collector; Cycle Hit Analyzer (CPV); Hits History Engine (HIV); Importance Prediction Engine (IPS Fusion); Marketplace and Orchestration Module; Privacy, Provenance and Fraud Layer; Calibration and Monitoring Module; Consent and Provenance Module; Optional Integration Modules including lending, insurance, and decentralized coordination.

Interaction Event Collector—Ingests timestamped events from APIs, agents, model hubs, vector stores, dataset marketplaces, prompt logs, workflow engines, and content delivery systems; normalizes fields, attaches regulatory and geographic tags, and writes append-only tamper-evident logs.

Event Fields and Storage—Normalized fields include timestamp, asset_id, event_type, client_id, latency_ms, success_flag, provenance_hash, region, regulatory_tag, and version_id; storage supports streaming and batch ingestion, configurable retention, and cryptographic anchoring.

Cycle Hit Analyzer (CPV)—Detects periodicity and transient surges using spectral analysis, sliding windows, attention-weighted recurrence, and Neural Hawkes encoders; encodes dominant frequency, amplitude, volatility, phase proxy, surge ratio, short-term slope, and surge confidence into CPV vectors per asset and time window.

CPV Techniques and Parameters—Implementations include periodogram, Welch method, continuous wavelet transforms, sliding window encoders with positional embeddings, attention recurrence, and Neural Hawkes with configurable hidden size and decay kernels; surge detectors compute surge confidence via statistical thresholds and learned surge classifiers.

Hits History Engine (HIV)—Constructs a directed, time-weighted influence graph linking assets; edges annotated with weight, provenance confidence, timestamp, time decay, and version lineage; nodes represent models, datasets, embeddings, prompts, workflows, or content objects.

HIV Analytics—Computes PageRank variants, adoption slope, propagation velocity, in/out weighted degrees, marginal contribution, lineage score, and temporal centrality to form an HIV vector per asset; provenance confidence reweights edge contributions.

IPS Fusion Architecture Overview—A multipath fusion engine ingests CPV, HIV, and contextual metadata and combines graph neural networks, temporal transformers, Neural Hawkes encoders, and context encoders for regulatory, geographic, and business tags; optional mixture-of-experts fusion and spatiotemporal attention blocks; outputs integrated to produce IPS vectors and calibrated confidence.

Mixture of Experts (MoE) Fusion Head—The MoE fusion head comprises multiple expert submodels and an adaptive gating network that computes per-asset gating scores; the gating network sparsely activates a subset of experts to route inference, optimizing accuracy and path reliability while controlling compute via sparsity regularizers and budget constraints.

Spatiotemporal Attention Block—A joint attention mechanism that computes attention weights across temporal tokens and graph neighbors, producing fused representations and attention heatmaps; supports positional encodings for time and structural encodings for graph adjacency.

Neural Hawkes and Self-Excitation Modeling—Neural Hawkes encoders model conditional event intensities, capture contagion and virality, and produce residuals used by sequence anomaly detectors; parameters include hidden dimension, kernel decay, and intensity thresholds.

Learning Modes and Continual Adaptation—Supports supervised, self-supervised, few-shot adaptation, continual learning, and reinforcement-learning fine-tuning; continual learning uses replay buffers, Elastic Weight Consolidation, LoRA adapters, and selective rehearsal to prevent catastrophic forgetting and enable rapid vertical adaptation.

Causal Discovery and Causal PDE Control—Causal discovery modules identify candidate causal drivers and prune spurious correlations; a causal control module models IPS trajectories and computes dynamic pricing and bundling policies by solving or approximating causal partial differential equation control problems or discrete control approximations.

Calibration and Conformal Prediction—A calibration module applies ensemble methods, Bayesian last layers, conformal prediction, and online temperature scaling; monitors Prediction Interval Coverage Probability and Adaptive Calibration Error; drift windows and triggers initiate online recalibration to maintain coverage under distribution shift.

Explainability and IPS Packet Structure—IPS outputs include decomposition vectors, attention heatmaps, Shapley-style marginal attributions, and counterfactual simulations. The IPS packet structure contains IPS values, calibrated confidence intervals, explainability decomposition, provenance metadata, consent token references, and signed metadata for auditability.

Provenance Anchoring and Consent Tokens—Compact provenance hashes are anchored to tamper-evident ledgers; consent tokens encode retention, permitted use scope, and revocation endpoints; marketplace actions verify consent tokens and provenance proofs prior to settlement or royalty distribution.

Fraud Detection and Dual Anomaly Nets—Fraud detection integrates an edge anomaly detector monitoring provenance shifts and edge weight drift, and a sequence anomaly detector monitoring temporal and surge anomalies using Hawkes residuals and sequence residual analysis; detections trigger loss reweighting, IPS penalization, increased uncertainty, and gating for human review.

Marketplace and Orchestration Module—Maps IPS and calibrated confidence to monetization and operational actions including dynamic pricing, bid floors, auctions, priority tiers, compute allocation, API routing, workflow orchestration, composite bundling, tokenized early access, royalty distribution, SLA brokerage, and compute liquidity pools.

Reinforcement Learning Pricing and Allocation—Reinforcement-learning agents consume IPS, explainability, and calibrated confidence to adjust bid floors, reserve prices, SLA tiers, and allocation policies; reward functions incorporate realized revenue, risk penalties, provenance confidence, and causal control signals; policies may be trained offline and deployed with online fine-tuning.

Composite Asset Marginal Contribution and Royalty Allocation—IPS computed for composite assets includes marginal contribution values per component derived via counterfactual removal tests and Shapley-style attributions to enable defensible bundle pricing and provenance-anchored royalty distribution.

Insurance, Hedging, and Financial Primitives—Insurance and hedging modules use IPS-calibrated variance and historical loss simulations to price premiums, compute collateral requirements, and construct hedging instruments; marketplace integrates insurance primitives to offer risk-adjusted products and collateralized settlement.

Tokenization and Settlement—Tokenization module mints, auctions, and transfers tokens or NFTs whose pricing or priority tiers are conditioned on IPS values and provenance scores; settlement workflows support escrow, automated liquidation, and on-chain or off-chain settlement with formal verification of enforcement logic.

Formal Verification for Smart Contracts—Formal verification module generates formal specifications of smart contract enforcement logic, applies model checking or theorem proving to verify correctness, and stores verification artifacts and proof certificates in tamper-evident logs linked to provenance records.

Trusted Execution Environments and Secure Enclaves—Sensitive computations execute within trusted execution environments or secure enclaves with remote attestation; enclave outputs are cryptographically signed and bound to provenance proofs to prevent tampering and enable auditable enforcement.

Training, Synthetic Data, and Secure Simulation—Training pipelines include privacy-preserving synthetic data generation, secure enclave simulations for rare-event stress testing, and adversarial training to improve robustness; secure simulation scenarios validate causal control, reinforcement-learning policies, and fraud suppression.

Representative Hyperparameters and Architectures—Example starting points include Neural Hawkes hidden dimension 128; Temporal Graph Transformer with 6 layers and 8 heads; GNN with 3 layers; MoE experts with top-k gating; MLP fusion layers; reinforcement-learning learning rates; history decay; conformal prediction windows; and calibration targets.

Representative Event Log Example—Example event: timestamp, asset identifier, event type, client identifier, latency, success flag, provenance hash, region, regulatory tag, and version.

Worked Example A—Surge in model usage produces CPV and HIV; IPS with calibrated confidence and provenance confidence informs tokenized early-access auctions, royalty reservation, and projected revenue uplift.

Worked Example B—Weekly spikes produce IPS and calibrated confidence; marketplace maps IPS to SLA tiering, compute reservation, and per-query SLA premiums, improving efficiency and reducing lead time.

Experimental Protocol (A/B Pilot)—A/B testing may be performed to evaluate IPS-driven ranking, pricing, or allocation policies using randomized traffic splits and uplift metrics.

(Intentionally removed—no drawings included.)

Lineage and Historical Context—Builds on earlier cycle and hits concepts and advances them with temporal graph transformers, Neural Hawkes, mixture-of-experts gating, spatiotemporal attention, calibrated uncertainty, causal PDE control, federated privacy, tokenized settlement, formal verification, and trusted execution environments.

Inventorship, Evidence, and Reduction to Practice—Preserve dated development logs, signed invention disclosures, git commits, experiment notebooks, pilot telemetry, calibration curves, formal verification artifacts, trusted execution environment attestation records, and demo videos in tamper-evident storage to support prosecution and inventorship assertions.

Claim Scope and Prosecution Strategy—File a core non-provisional covering modular IPS architecture and monetization primitives; include independent claims for system, method, and medium and dependent claims for mixture-of-experts, spatiotemporal attention, causal control, calibration, consent and provenance, dual anomaly nets, insurance, formal verification, and trusted execution environments; follow with continuations and divisionals for specific technical embodiments and vertical adapters.

Fallback Embodiments—Simpler embodiments compute IPS using time-weighted aggregates, exponential decay, normalized activity counts, and learned weighting parameters to approximate emergent importance when full fusion is not available.

Implementation and Deployment Notes—Support streaming and batch pipelines, microservice modularization, API gateways for third-party integrators, feature caching, model sharding, and monitoring and alerting for provenance and fraud signals; provide SDKs and sample clients for rapid integration.

Security, Compliance, and Auditability—Use trusted execution environments for sensitive computations, cryptographic proofs for provenance, audit trails for human gating, compliance oracles for jurisdictional enforcement, and formal verification for settlement logic to ensure enforceable, auditable monetization.

APIs and Third-Party Integration—Expose REST and gRPC APIs and SDKs for ranked lists, IPS values, pricing recommendations, provenance proofs, consent verification, and custom business rule registration; include human gating endpoints and audit log retrieval.

Commercialization and Go-to-Market—Prioritize pilots in media, advertising technology, enterprise search, healthcare, and finance; partner with compute and catalog vendors and cloud marketplaces; monetize via subscriptions, transaction fees, revenue share, managed services, insurance products, and tokenized settlement fees.

Evidence of Utility—Worked examples, pilot protocols, and representative hyperparameters demonstrate practical utility, measurable uplift, and operational feasibility across multiple verticals.

Appendix—Illustrative IPS packet structures may include IPS values, calibrated confidence intervals, explainability components, provenance metadata, and consent token references.

Closing Statement—The specification provides technical modules, algorithmic options, representative parameters, and worked scenarios to enable implementation and support prosecution.

1. A computer-implemented system for predicting and monetizing emerging importance of AI assets, comprising:
(a) an interaction event collector configured to receive and normalize timestamped interaction events associated with AI assets and to write tamper-evident logs [0006]-[0009];
(b) a cycle hit analyzer configured to detect cyclical and surge interaction patterns and to output a Cycle Pattern Vector (CPV) using sliding windows, spectral analysis, and Neural Hawkes encoders [0008]-[0013];
(c) a hits history engine configured to construct a directed, time-weighted influence graph and to output a Historical Influence Vector (HIV) with provenance-reweighted edge contributions [0010]-[0016];
(d) a prediction engine configured to fuse the CPV and the HIV using one or more learned models including GNN, Temporal Transformer, and Neural Hawkes encoder paths and to generate an Importance Prediction Score (IPS) for each AI asset, the prediction engine further configured to output an explainable decomposition of IPS and a calibrated confidence interval [0012]-[0019], [0022]-[0024];
(e) a marketplace and orchestration module configured to apply IPS values and calibrated confidence to at least one monetization or orchestration action selected from dynamic pricing, bid floor setting, auction clearing, priority tiers, compute allocation, API routing, workflow orchestration, composite asset bundling, tokenization, royalty distribution, and SLA brokerage [0022], [0031]-[0035];
(f) a privacy, provenance, and fraud layer configured to perform federated learning with secure aggregation and differential privacy, to maintain tamper-evident provenance and consent metadata with optional on-chain anchoring, and to detect and suppress adversarial or manipulated signals prior to IPS consumption using dual anomaly detectors and adversarial training loops [0020], [0021], [0028], [0030]; and
(g) wherein the system implements human-in-the-loop gating for high-value allocations and exposes APIs and SDKs for third-party integrators [0005], [0045].

2. A method for forecasting, prioritizing, and monetizing AI asset importance, comprising:
(a) collecting timestamped interaction events for AI assets [0006]-[0009];
(b) generating a Cycle Pattern Vector and a Historical Influence Vector for the AI assets [0008]-[0016];
(c) computing an Importance Prediction Score for each AI asset by fusing the Cycle Pattern Vector and the Historical Influence Vector using a hybrid machine-learning model and producing a calibrated confidence interval and explainable decomposition [0012]-[0019], [0022]-[0024];
(d) applying the Importance Prediction Score and calibrated confidence to dynamically update at least one monetization or orchestration action selected from pricing, auctions, bid floors, ranking, routing, compute allocation, API request prioritization, workflow orchestration, composite asset bundling, tokenization, royalty distribution, or SLA brokerage [0022], [0031]-[0035];
(e) reevaluating the Importance Prediction Score in near real time upon receipt of new interaction events [0006], [0011]; and
(f) performing privacy-preserving model updates using federated learning with secure aggregation [0020], [0028].

3. A non-transitory computer-readable medium storing instructions that, when executed by one or more processors, cause the processors to perform the method of claim 2 [0006]-[0024].

4. The system of claim 1, wherein the prediction engine comprises a Mixture of Experts (MoE) fusion head with adaptive gating and sparsity regularizers to control compute budget [0013].

5. The system of claim 1, further comprising a spatiotemporal attention block that computes joint attention across temporal tokens and graph neighbors and outputs attention heatmaps for explainability [0014], [0025].

6. The system of claim 1, further comprising a causal control module that models IPS trajectories and computes dynamic pricing policies via causal PDE control or discrete control approximations [0017].

7. The system of claim 1, wherein the calibration module applies ensemble calibration, conformal prediction, and online temperature scaling and monitors PICP and ACE [0022]-[0024].

8. The system of claim 1, wherein the privacy and provenance module issues and validates consent tokens and anchors provenance hashes to tamper-evident ledgers [0020], [0026].

9. The system of claim 1, wherein fraud detection comprises edge anomaly and sequence anomaly detectors that trigger IPS penalization, increased uncertainty, and human gating [0021], [0030].

10. The system of claim 1, further comprising an insurance and hedging module that uses IPS calibrated variance and historical loss simulations to price premiums and compute collateral [0034].

11. The system of claim 1, wherein settlement logic and smart contracts are subject to formal verification and verification artifacts are stored in tamper-evident logs [0027].

12. The system of claim 1, wherein sensitive computations execute within trusted execution environments (TEEs) with remote attestation and signed enclave outputs bound to provenance proofs [0028], [0036].

13. The system of claim 1, wherein reinforcement learning agents adjust pricing and allocation policies using IPS, explainability, and calibrated confidence [0023], [0032].

14. The system of claim 1, wherein composite asset IPS includes marginal contribution per component derived via counterfactual removal tests and Shapley-style attributions [0024].

15. The system of claim 1, wherein tokenization mints tokens or NFTs conditioned on IPS and provenance scores and supports escrow and automated liquidation [0026].

16. The system of claim 1, further comprising a lending signals layer that uses IPS to inform credit or collateral decisions [0034].

17. The system of claim 1, wherein CPV computation uses periodogram, Welch method, or continuous wavelet transforms as disclosed [0008]-[0009].

18. The system of claim 1, wherein HIV analytics include PageRank variants, propagation velocity, and temporal centrality as disclosed [0011], [0014]-[0016].

19. The system of claim 1, wherein prediction engine variants include GNN, Transformer, Hawkes, and gradient boosting experts [0012]-[0013].

20. The system of claim 1, wherein fraud detection training includes adversarial training and secure simulation scenarios to harden detectors [0021], [0029].

21. The system of claim 1, wherein a fallback IPS computation uses time-weighted aggregates, exponential decay, and normalized activity counts [0039].

22. The system of claim 1, wherein APIs and SDKs are exposed for third-party integrators for ranked lists, IPS values, pricing recommendations, provenance proofs, and consent verification [0045].

23. The system of claim 1, wherein continual learning uses replay buffers, Elastic Weight Consolidation, and LoRA adapters [0016], [0039].

24. The system of claim 1, wherein calibration monitoring computes PICP and ACE and triggers recalibration windows [0022]-[0024].

25. The system of claim 1, wherein a Priority Broker maps IPS ranges and confidence to marketplace actions and human gating thresholds [0022], [0031].

26. The system of claim 1, wherein a compute liquidity pool allocates compute resources based on IPS and SLA tiers [0031].

27. The system of claim 1, wherein settlement supports multicurrency onchain or offchain settlement [0026].

28. The system of claim 1, wherein human-in-the-loop gating records audit trails and gating decisions in an append-only audit log [0005], [0028].

29. The system of claim 1, wherein development logs, calibration curves, pilot telemetry, TEE attestations, and formal verification artifacts are preserved in tamper-evident storage to support prosecution and inventorship [0050].

30. The system of claim 1, wherein vertical adapters tailor CPV/HIV fusion and marketplace rules for industry domains including media, adtech, enterprise search, healthcare, and finance [0031], [0043].
